(19) United States
(12) Patent Application Publication
(10) Pub. No.: US 2011/0038143 A1
(43) Pub. Date: Feb. 17, 2011

(54) Drive tool with pivotal lamp

(76) Inventor: Chang Yang Huang, Taichung (TW)

Correspondence Address: SAM CHEN, 7F-1, 293, ROOSEVELT ROAD, SEC 3, TAIPEI, TW

(21) Appl. No.: 12/538,874

(22) Filed: Aug. 11, 2009

(51) Int. Cl. B25B 27/00

(52) U.S. Cl. 362/120; 362/194

(57) ABSTRACT

A drive tool includes an outer sleeve; an inner sleeve of rectangular cross-section slidably disposed in the outer sleeve and comprising a battery window formed on a first surface, a switch window formed on the first surface, a first opening formed on a second surface, and a second opening formed on a third surface opposing the second surface; a joint releasably secured to the inner sleeve; and a lamp assembly fastened in the inner sleeve and comprising a battery compartment aligned with the battery window, a switch aligned with the switch window, and a pivotal lamp including a first cavity open to the first opening, a second cavity open to the second opening, and a bulb disposed between the first and second cavities. The lamp can be manually pivoted to either project out of the first opening or project out of the second opening.

### BACKGROUND OF THE INVENTION

1. Field of Invention

The invention relates to drive tools and more particularly to a drive tool having a pivotal lamp so that an illumination angle of the lamp can be easily adjusted when working in a dark environment.

2. Description of Related Art

Illuminated tools are well known in the art. Illuminated tools are typically used in a dark environment. However, the well known illuminated tools are disadvantageous because their illumination angles are not adjustable. Hence, they are not convenient in use. Thus, the need for improvement still exists.

### SUMMARY OF THE INVENTION

It is therefore one object of the invention to provide a drive tool having a pivotal lamp so that an illumination angle of the lamp can be easily adjusted when working in a dark environment.

The above and other objects, features and advantages of the invention will become apparent from the following detailed description taken with the accompanying drawings.

### BRIEF DESCRIPTION OF THE DRAWINGS

FIG. 1A is an exploded perspective view of a first preferred embodiment of illuminated drive tool according to the invention where a first type of joint is to be assembled therewith;

FIG. 1B is an exploded perspective view of the first preferred embodiment of illuminated drive tool according to the invention where a second type of joint is to be assembled therewith;

FIG. 2 is a longitudinal sectional view of a front portion of the assembled inner sleeve and lamp assembly shown in either FIG. 1A or FIG. 1B;

FIG. 3 is a view similar to FIG. 2 where the lamp has pivoted to the left;

FIG. 4 is a view similar to FIG. 2 where the lamp has pivoted to the right; and

FIG. 5 is a longitudinal sectional view of a front portion of assembled inner sleeve and lamp assembly of an illuminated drive tool according to a second preferred embodiment of the invention.

### DETAILED DESCRIPTION OF THE INVENTION

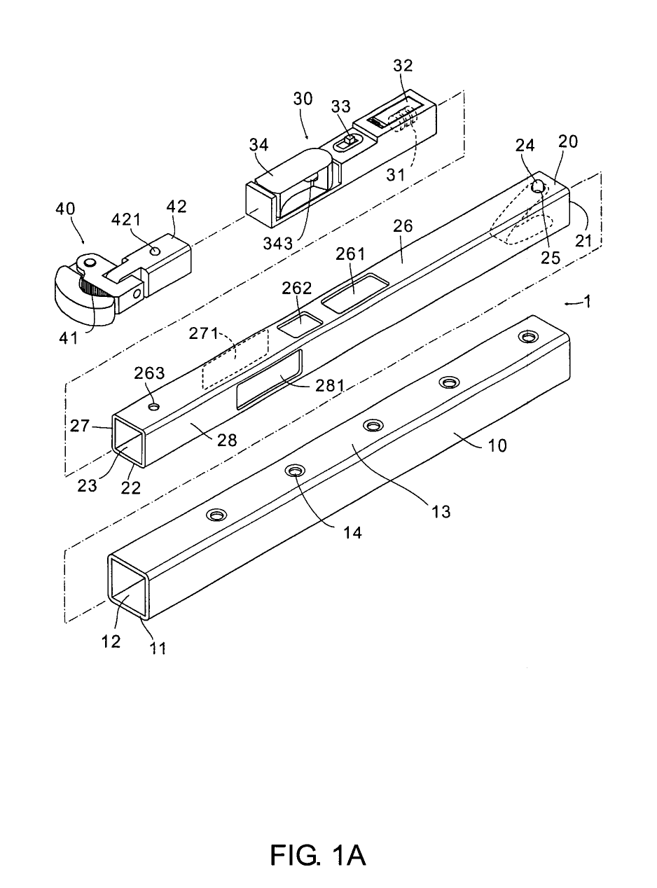

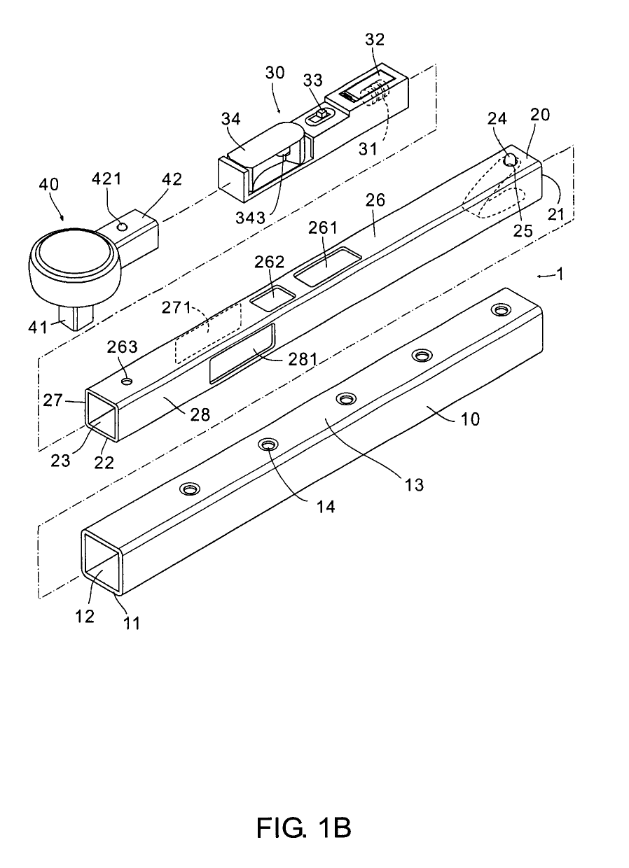

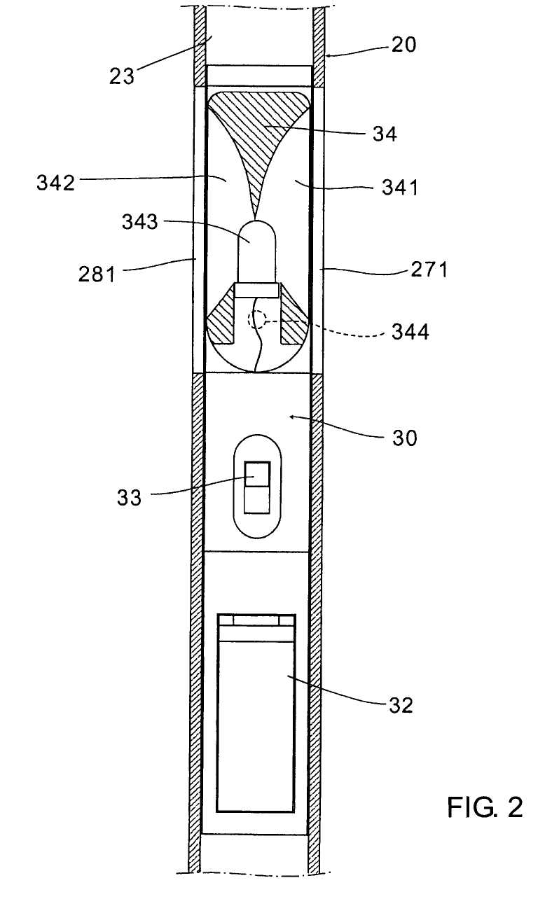

Referring to FIGS. 1A to 4, an illuminated drive tool 1 in accordance with a first preferred embodiment of the invention is shown. The drive tool 1 is implemented as a handle of a wrench (e.g., socket wrench). The drive tool 1 comprises the following components as discussed in detail below.

An outer sleeve 10 of rectangular cross-section comprises a blind end (not shown), an open end 11 opposite the blind end, an internal space 12 defined between the ends, and a plurality of (five are shown) equally spaced apertures 14 on one surface 13, the apertures 14 on one surface 13 being communicated with the space 12.

An inner sleeve 20 of rectangular cross-section is shaped to be capable of slidingly disposing and moving in the space 12. The inner sleeve 20 comprises one end 21, the other end 22, an internal space 23 defined between the ends, a first positioning aperture 25 on a first surface 26 proximate one end 21, a spring depressible detent 24 fastened in a location proximate the one end 21 and having a head (not numbered) resiliently projecting out of the first positioning aperture 25 to be adapted to lockingly dispose in one of the apertures 24 by sliding the inner sleeve 20 in the outer sleeve 10 (i.e., the length of the drive tool 1 being adjustable), a rectangular battery window 261 and an adjacent rectangular switch window 262 both on an intermediate portion of the first surface 26, a rectangular first opening 271 on a second surface 27, a rectangular second opening 281 on a third surface 28 opposing the second surface 27, the first and second openings 271, 281 being of the same size, and a second positioning aperture 263 on the first surface 26 proximate the other end 22.

A lamp assembly 30 is substantially a rectangular body and is shaped to securely fasten in a portion of the inner sleeve 20 substantially from a rear end of the battery window 261 to front ends of both the first and second openings 271, 281. The lamp assembly 30 comprises a rear battery compartment 32 with one or more batteries 31 being fastened therein, the battery compartment 32 being aligned with the battery window 261 thereabove, an intermediate sliding switch 33 aligned with the switch window 262 thereabove, and a front lamp 34 between the first and second openings 271 and 281, the lamp 34 including a first cavity 341 open to the first opening 271, a second cavity 342 open to the second opening 281, an intermediate bulb 343 between the first and second cavities 341 and 342, and a pivot pin 344 for pivotably securing the lamp 34 to the lamp assembly 30.

The switch 33, the batteries 31, and the bulb 343 are electrically connected together. The switch 33 is manually moveable between on and off positions to either electrically connect the batteries 31 to the bulb 343 when the switch 33 is in its on position or electrically disconnect the batteries 31 from the bulb 343 when the switch 33 is in its off position.

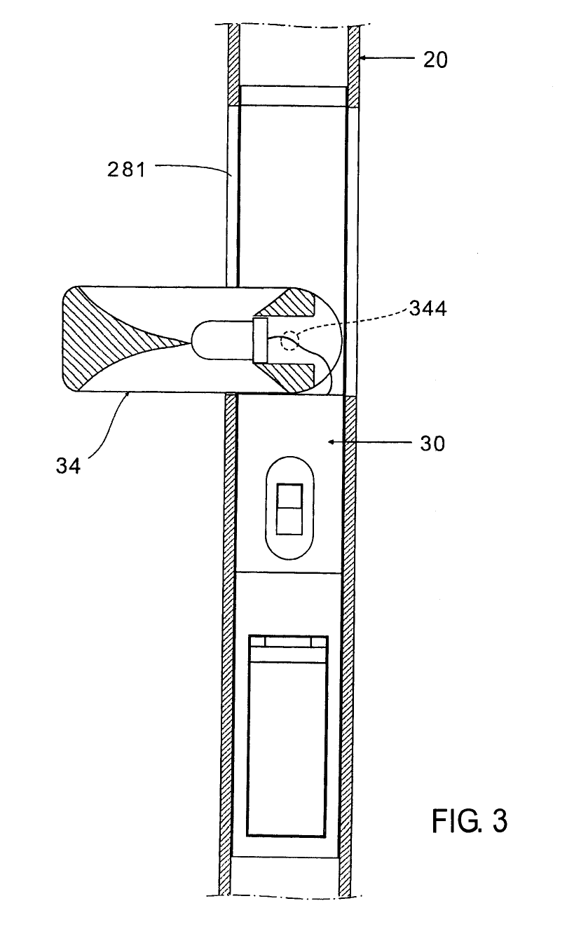

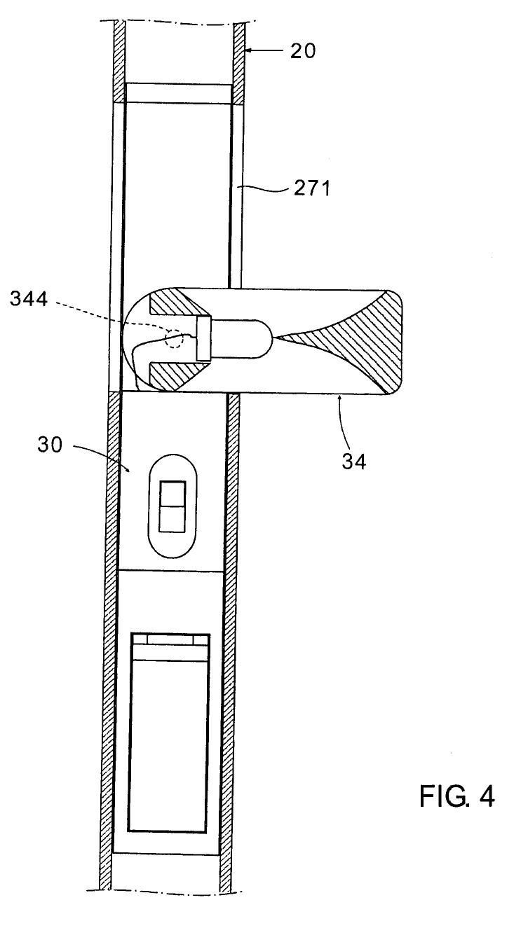

In one operation the lamp 34 is manually pivoted leftward to project out of the second opening 281 as shown in FIG. 3. In the other operation the lamp 34 is manually pivoted rightward to project out of the first opening 271 as shown in FIG. 4. It is shown that the lamp 34 is capable of pivoting about 180 degrees from the position of FIG. 3 to that of FIG. 4 or vice versa. That is, an illumination angle of the bulb 343 can be adjusted in the range of 0 degree to 180 degrees. Therefore, the drive tool 1 is highly adaptable when working in a dark environment.

As shown in FIG. 1A specifically, a first type of joint 40 comprises a front first coupling member (e.g., clamp) 41 and a rear second coupling member 42 of rectangular section, the second coupling member 42 having a half-spherical projection 421 adapted to lockingly secure to the second positioning aperture 263 when the joint 40 is fastened in a front portion of the inner sleeve 20. The first coupling member 41 is exposed in the fastened position of the joint 40.

As shown in FIG. 1B specifically, a second type of joint 40 comprises a front first coupling member 41 of rectangular section and a rear second coupling member 42 of rectangular section, the second coupling member 42 being perpendicular to the first coupling member 41 and having a half-spherical projection 421 adapted to lockingly secure to the second positioning aperture 263 when the joint 40 is fastened in a front portion of the inner sleeve 20. The first coupling member 41 is exposed in the fastened position of the joint 40.

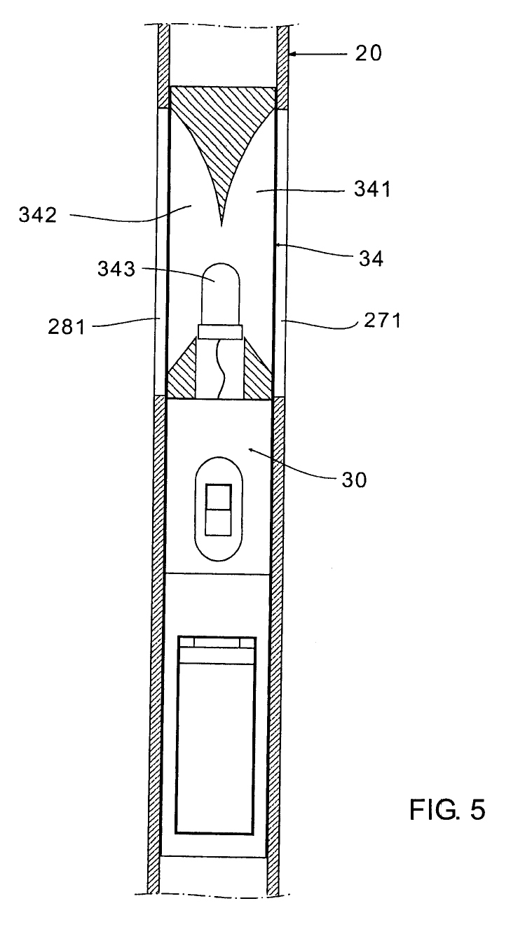

Referring to FIG. 5, a longitudinal sectional view of a front portion of assembled inner sleeve 20 and lamp assembly 30 of an illuminated drive tool according to a second preferred embodiment of the invention is shown. The characteristics of the second preferred embodiment are detailed below.

The lamp 34 is fixedly secured to the lamp assembly 30. Hence, light rays emitted by the energized bulb 343 may pass the first cavity 341 and the first opening 271 (i.e., right side) and the second cavity 342 and the second opening 281 (i.e., left side) respectively for illumination.

While the invention herein disclosed has been described by means of specific embodiments, numerous modifications and variations could be made thereto by those skilled in the art without departing from the scope and spirit of the invention set forth in the claims.

What is claimed is:

1. A drive tool comprising:
an outer sleeve;
an inner sleeve of rectangular cross-section, the inner sleeve being slidably disposed in the outer sleeve and comprising a battery window formed on a first surface, a switch window formed on the first surface, a first opening formed on a second surface, and a second opening formed on a third surface opposing the second surface;
a joint releasably secured to front portions of the first and second openings; and
a lamp assembly fastened in the inner sleeve and comprising a compartment with at least one battery being held therein, the compartment being aligned with the battery window, a switch aligned with the switch window, and a pivotal lamp including a first cavity open to the first opening, a second cavity open to the second opening, and a bulb disposed between the first and second cavities,
wherein the switch, the at least one battery, and the bulb are electrically connected together; and
wherein the lamp can be manually pivoted to either project out of the first opening to dispose in a first position or project out of the second opening to dispose in a second position.

2. The drive tool of claim 1, wherein the first and second openings are of the same size.

3. The drive tool of claim 1, wherein the first position of the lamp is at an angle of about 180 degrees with respect to the second position thereof.
